(19) United States
(12) Patent Application Publication
(10) Pub. No.: US 2026/0281385 A1
(43) Pub. Date: Sep. 17, 2026

(54) MEDIA SYNCHRONIZATION FOR CLOUD PROCESSING

(71) Applicant: NVIDIA Corporation, Santa Clara, CA (US)

(72) Inventors: Chetan Purushottam SETHI, Pune (IN); Bhushan RUPDE, Pune (IN)

(73) Assignee: NVIDIA Corporation, Santa Clara, CA (US)

(21) Appl. No.: 19/079,050

(22) Filed: Mar. 13, 2025

(51) Int. Cl. H04N 19/172; G06T 17/00; H04N 19/70

(52) U.S. Cl. CPC H04N 19/172; G06T 17/00; H04N 19/70

(57) ABSTRACT

Systems and methods for implementing media synchronization for cloud processing are disclosed. A system can encode a plurality of video frames to generate a plurality of encoded frames, where the video frames are associated with corresponding audio. The system can update a respective header of at least one of the plurality of encoded frames to include encoded audio generated from the corresponding audio. The system can transmit one or more network packets including the plurality of encoded frames as part of a video stream. This approach ensures that audio and video data remain synchronized by embedding the audio data within the video frames, thereby reducing the likelihood of desynchronization due to network latency or packet loss.

### BACKGROUND

Video streaming systems transmit encoded audio and video data over networks by dividing the data into streams of packets, using separate streams for audio and video, and synchronizing them using timestamp information. However, such approaches can result in desynchronization due to latency differences or varying network conditions affecting the separate streams.

### SUMMARY

Video streaming systems often face challenges in synchronizing audio and video data when transmitted over networks. Conventional approaches typically involve sending audio and video as separate streams, using protocols like the real time streaming protocol (RTSP), with synchronization relying on timestamp information. However, this method can lead to desynchronization due to differences in network conditions, latency, or packet loss affecting each stream differently. These issues are particularly problematic in distributed computing environments, such as two-dimensional (2D) to three-dimensional (3D) video conferencing, in which remote systems process media before transmission, further complicating synchronization.

The techniques described herein address these challenges by transmitting both encoded audio and video data in a single media stream. Instead of using separate streams, the audio data is embedded as metadata within the encoded video packets, such as in Supplemental Enhancement Information (SEI) fields. This approach ensures that audio remains synchronized with the corresponding video frames, as both are transmitted together. For example, in a 2D-to-3D video conferencing application, the sender system encodes audio and video together, and the remote processing system decodes and processes the data before re-embedding the audio into the regenerated/recovered video packets. This method eliminates desynchronization issues caused by network variability, ensuring that audio and video remain aligned during playback.

At least one aspect relates to one or more processors. The one or more processors can include one or more circuits. The one or more circuits can encode a plurality of video frames to generate a plurality of encoded frames, the plurality of video frames associated with corresponding audio. The one or more circuits can update a respective header of at least one of the plurality of encoded frames to include encoded audio generated from the corresponding audio (e.g., audio corresponding to and synchronized with the video frames). The one or more circuits can transmit one or more network packets including the plurality of encoded frames as part of a video stream (e.g., with audio data incorporated into headers of the encoded frames).

In some implementations, the one or more circuits can generate a plurality of encoded audio frames from the corresponding audio. In some implementations, the one or more circuits can update the respective header of one or more of the plurality of encoded frames to include a respective encoded audio frame of the plurality of encoded audio frames. In some implementations, the one or more processors can select, based at least on a framerate of the video stream, a subset of the plurality of encoded frames to update to include one or more of the plurality of encoded audio frames. In some implementations, the encoded audio is stored as a plurality of encoded audio frames, and the one or more processors can determine a playback duration (e.g., 20ms) of each of the plurality of encoded audio frames. In some implementations, the one or more processors can select the subset of the plurality of encoded frames further based at least on the playback duration (e.g., select some of the frames to update, where the framerate of the video and framerate of audio differ).

In some implementations, the one or more processors can update the respective header to include the encoded audio as Supplemental Enhancement Information (SEI) metadata. In some implementations, the one or more processors can receive feedback from a computing system indicating network performance information. In some implementations, the one or more processors can dynamically adjust a bit rate of the video stream based at least on the network performance data. In some implementations, the plurality of encoded frames is generated according to one of a H.264 format or a H.265 format (e.g., format that support SEI fields). In some implementations, the one or more circuits can transmit the plurality of network packets including the plurality of encoded frames via a single real-time transport protocol (RTP) port.

At least one aspect relates to a system. The system can include one or more processors. The system can receive one or more network packets comprising one or more encoded video frames of a video stream. The system can extract one or more encoded audio frames from respective headers of the one or more encoded video frames. The system can decode the one or more encoded video frames and the one or more encoded audio frames to generate one or more decoded video frames and decoded audio data. The system can provide the one or more decoded video frames and the audio data for presentation or processing.

In some implementations, the system can deserialize the video stream to generate the one or more encoded video frames. In some implementations, the system can extract the one or more audio frames from at least one SEI fields of the respective headers of the one or more encoded video frames. In some implementations, the system can extract 3D rendering metadata from the respective headers of the one or more encoded video frames. In some implementations, the system can render a 3D output based at least on the 3D rendering metadata and the decoded video frames. In some implementations, the system can generate 3D rendering metadata using the one or more decoded video frames. In some implementations, the system can re-encode the one or more decoded video frames and the audio data to generate one or more re-encoded video frames and re-encoded audio data. In some implementations, the system can update a respective header of at least one of the one or more re-encoded video frames to include the re-encoded audio data and the 3D rendering metadata. In some implementations, the system can transmit one or more network packets including the one or more re-encoded video frames as part of a video stream.

At least one other aspect relates to a method. The method can include encoding, using one or more processors, a plurality of video frames to generate a plurality of encoded frames, the plurality of video frames associated with corresponding audio. The method can include updating, using the one or more processors, a respective header of at least one of the plurality of encoded frames to include encoded audio generated from the corresponding audio. The method can include transmitting, using the one or more processors, one or more network packets including the plurality of encoded frames as part of a video stream.

In some implementations, the method can include generating, using the one or more processors, a plurality of encoded audio frames from the corresponding audio. In some implementations, the method can include updating, using the one or more processors, the respective header of one or more of the plurality of encoded frames to include a respective encoded audio frame of the plurality of encoded audio frames. In some implementations, the method can include selecting, using the one or more processors, based at least on a framerate of the video stream, a subset of the plurality of encoded frames to update to include one or more of the plurality of encoded audio frames. In some implementations, the encoded audio is stored as a plurality of encoded audio frames, and the method can include determining, using the one or more processors, a playback duration of each of the plurality of encoded audio frames. In some implementations, the method can include selecting, using the one or more processors, the subset of the plurality of encoded frames further based at least on the playback duration.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a multi-modal language model, a system for performing generative AI operations using a small language model, a system for performing generative AI operations using a large language model, a system for performing generative AI operations using a vision language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing media synchronization for cloud processing are described in detail below with reference to the attached drawing figures, wherein:

FIG. 1 is a block diagram of an example system for implementing media synchronization for cloud processing, in accordance with some embodiments of the present disclosure;

FIG. 2 is a block diagram showing an example environment in which the media synchronization techniques described herein can be implemented for an example conferencing application, in accordance with some embodiments of the present disclosure;

FIG. 3 is a flow diagram of an example method for implementing media synchronization for cloud processing, in accordance with some embodiments of the present disclosure;

FIG. 4 is a block diagram of an example computing device suitable for use in implementing at least some embodiments of the present disclosure; and

FIG. 5 is a block diagram of an example data center suitable for use in implementing at least some embodiments of the present disclosure.

### DETAILED DESCRIPTION

This disclosure relates to systems and methods for synchronizing video data and audio data in video streaming systems. Video streaming can involve transmitting both encoded audio and encoded video data over networks by dividing the audio and video data in streams of packets. The packets can be transmitted as video data and audio data are generated. Receiver systems can receive the encoded video and audio packets and perform local decoding and playback of the video and audio content.

In some implementations, remote computing systems may perform additional processing of encoded video and/or audio prior to transmitting the media to a receiver system. In one example, a two-dimensional (2D) to three-dimensional (3D) video conferencing application may include a remote computing system that receives a 2D video stream and processes the 2D video stream to generate corresponding 3D mesh data. The 3D mesh data can be transmitted to a receiver system for rendering with corresponding audio data, which can be provided in a separate audio stream.

Synchronizing audio and video data in such distributed computing environments can be challenging. Traditional approaches for synchronized media streaming involve transmitting separate streams of packets for audio and video data and synchronizing using timestamp information included in or derived from each stream. For example, audio and video can be provided using different Real-Time Streaming Protocol (RTSP) ports. However, transmitting separate streams for video data and audio data can result in desynchronization due to latency differences or differences in network conditions that affect both streams of media data differently.

To address these issues, the techniques described herein can transmit both encoded audio data and encoded video data in a single media stream. To do so, rather than transmitting encoded audio data in a separate stream of packets, the systems and methods described herein can automatically encode the audio data as part of the metadata of the encoded video packets. In some implementations, the encoded audio data can be entirely embedded within Supplemental Enhancement Information (SEI) fields or other header fields of the encoded video frames. The encoded audio data can be subdivided according to the framerate of the video data, such that the audio data is always synchronized with the portion of the video data with which it is stored.

Furthering the 2D to 3D video conferencing example above, a sender system can encode both video and audio data according to the techniques described herein to transmit a single stream of packets to a remote computing system for processing. For example, the encoded media data can be transmitted as a single composite stream over a single Real-Time Protocol (RTP) port. The remote processing system can receive and decode the stream, extracting both the encoded audio and video data. The remote processing system can process the 2D video to produce a 3D video output and can regenerate/recover an encoded video packet that includes both the processed 3D video data and the original encoded audio data embedded within the metadata.

After regenerating the encoded packet, the processing system can transmit the processed and encoded video data to the receiver system. On receipt, the receiver system decodes the video packet, extracting the previously embedded metadata including the encoded audio data and the processed 3D video data. The receiver system can render and display the 3D video while decoding and providing the audio output. The synchronization between the video and audio is maintained since audio data is stored and transmitted with the frames for video data to which the audio data corresponds, and therefore cannot be desynchronized due to changes in network latency, dropped packets, or other network interruptions.

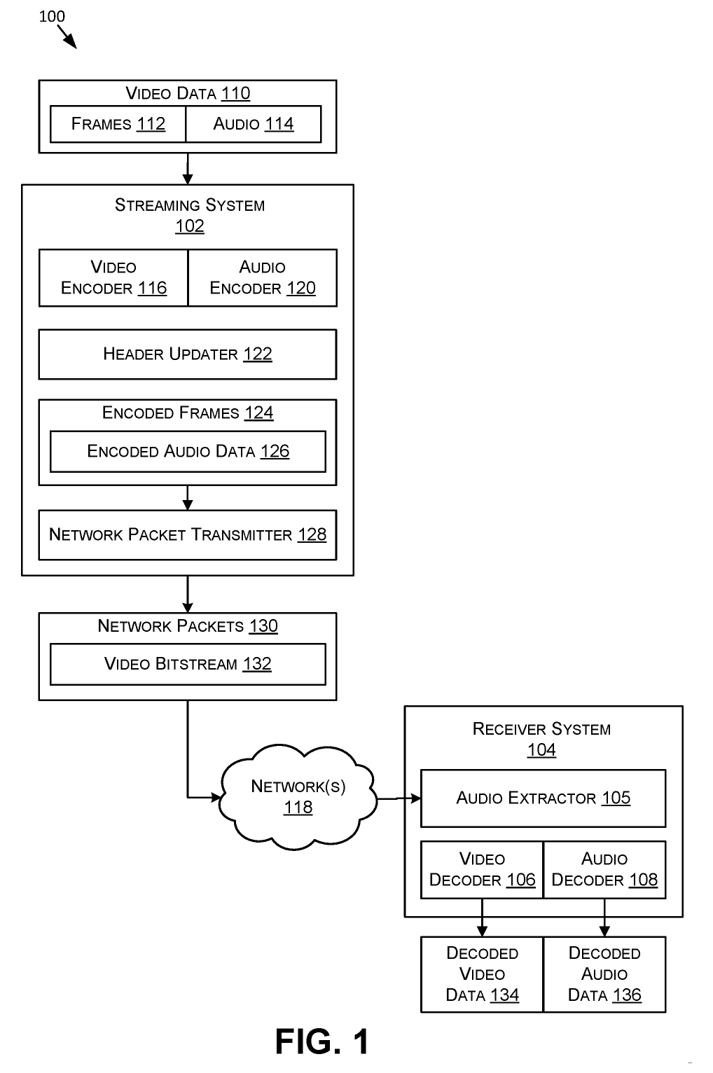

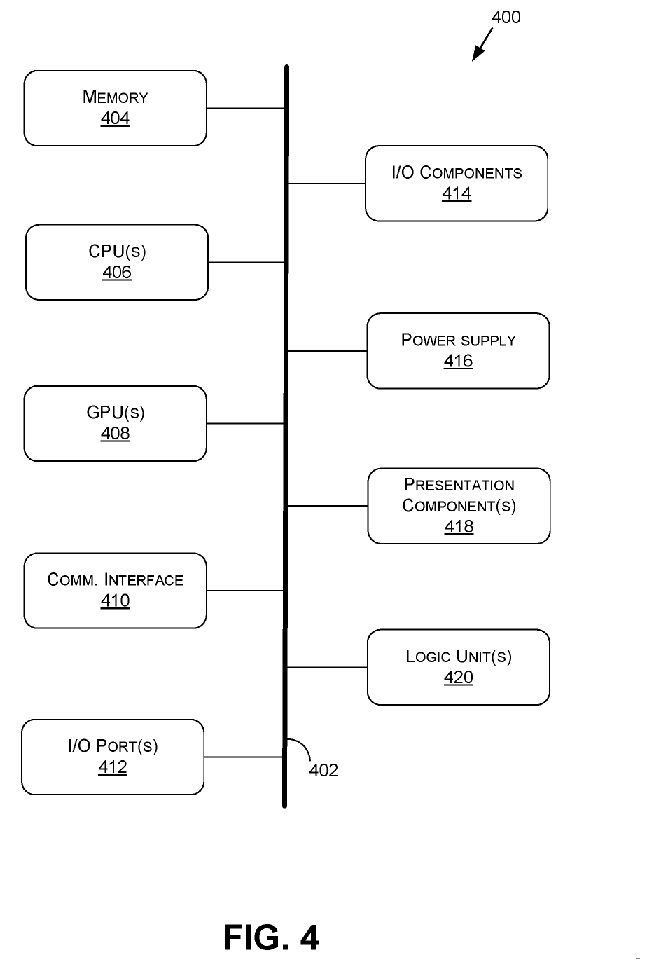

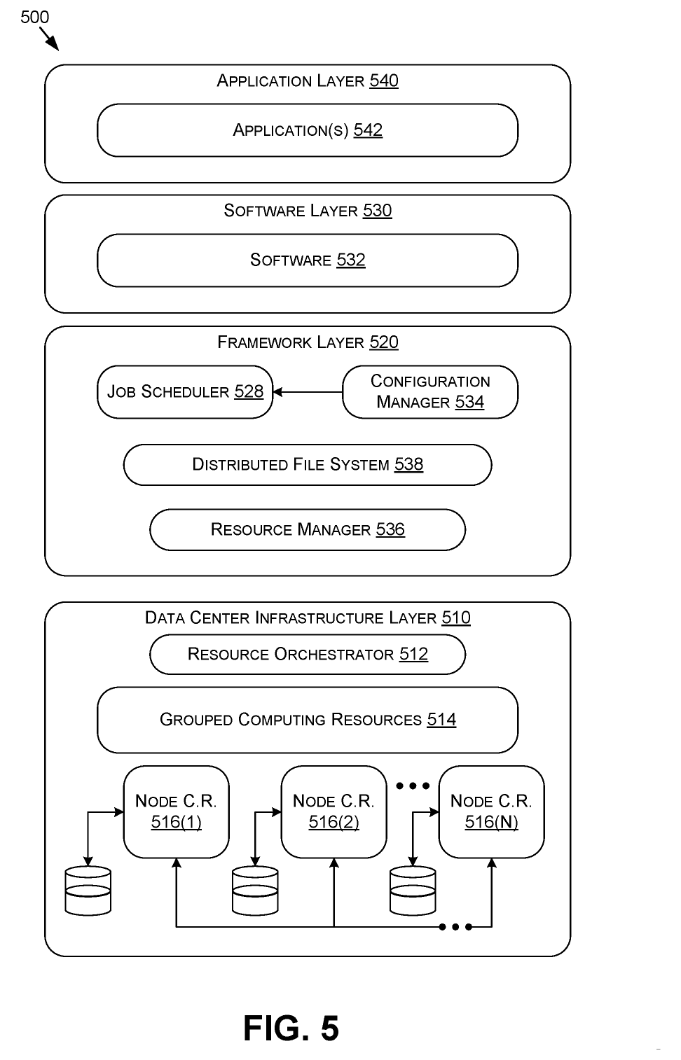

With reference to FIG. 1, FIG. 1 is an example computing environment including a system 100 for implementing media synchronization for cloud processing, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some implementations, the system and methods described herein may be implemented using one or more computing devices or components thereof (e.g., as described in FIG. 4), and/or one or more data centers or components thereof (e.g., as described in FIG. 5).

The system 100 can be used to implement media synchronization for cloud processing. The system 100 is shown as including a streaming system 102 that can process video data 110 and receiver system 104. The video data 110 is shown as including frames 112 and audio data 114. The streaming system 102 is shown as including a video encoder 116, an audio encoder 120, a header updater 122, one or more encoded frames 124, and a network packet transmitter 128. The one or more encoded frames 124 are shown as including encoded audio data 126. The data processing system 102 is shown as transmitting one or more network packets 130 including a video bitstream 132 via one or more networks 118. The receiver system 104 is shown as including an audio extractor 105, a video decoder 106, and an audio decoder 108. The receiver system 104 is shown as providing decoded video data 134 and decoded audio data 136.

The streaming system 102 can include one or more processors, circuits, memory, and/or computing devices/systems that can perform the various techniques described herein. The streaming system 102 can be implemented, for example, using any type of computing device, including but not limited to a personal computing device, a mobile computing device, or a distributed computing device. In some implementations, the streaming system 102 can be implemented in a data center or in a cloud computing environment. The receiver system 104 can include one or more processors, circuits, memory, and/or computing devices/systems that can perform the various techniques described herein. The receiver system 104 can be implemented, for example, using any type of computing device, including but not limited to a personal computing device, a mobile computing device, or a distributed computing device. In some implementations, the receiver system 104 can be implemented in a data center or in a cloud computing environment. In some implementations, the receiver system 104 and the streaming system 102 can be implemented as part of the same computing system or distributed computing system. In some implementations, the receiver system 104 and the streaming system 102 can be implemented as different computing systems.

The network 118 can facilitate communication between the streaming system 102 and the receiver system 104. The network 118 `can include computer networks such as the Internet, local, wide, metro or other area networks, intranets, satellite networks, other computer networks such as voice or data mobile phone communication networks, and combinations thereof. The streaming system 102 and the receiver system 104 of the system 100 can communicate via network 118, as shown. The network 118 may be any form of computer network that can relay information between any of the computing devices described herein. In some implementations, network 118 may include the Internet and/or other types of data networks, such as a local area network (LAN), a wide area network (WAN), a cellular network, a satellite network, or other types of data networks. The network 118 may include any number of computing devices (e.g., computers, servers, routers, network switches, etc.) that can receive and/or transmit data within the network 118. The network 118 may further include any number of hardwired and/or wireless connections.

The streaming system 102 can generate, receive, or otherwise access video data 110. The streaming system 102 can be any type of computing device and may include one or more processors and memory. The streaming system 102 can process, stream, or otherwise provide the video data 110 via the network 118. The video data 110 can represent a variety of digital video content, including raw or processed visual information. The video data 110 can include, for example, live video feeds, pre-recorded video content, or generated graphical data of one or more applications (e.g., gaming applications, etc.). The video data 110 can include a sequence of video frames 112. Each frame 112 represents a still image (e.g., pixel data, etc.) captured at a specific point in time of the video stream. The frames 112 can be stored or accessed sequentially and can correspond to a frame rate of a video stream. Each frame 112 can include pixel data, metadata, and/or timestamps or sequence information.

The video data 110 can originate from a variety of sources, including but not limited to cameras, video recording devices, or processes executing at the streaming system 102 or a computing device in communication with the streaming system 102. For example, the video data 110 can be captured in real-time by a camera system, generated as output from a pre-recorded video file, or produced by a network gaming application or other interactive graphical application. In some implementations, the frames 112 of the video data 110 can be generated synthetically, such as through 3D rendering processes. In some implementations, the video data 110 can also be processed or modified prior to or during encode (as described in further detail herein), such as through compression, filtering, or enhancement.

The audio data 114 can be associated with the video data 110 as part of a multimedia stream, where the frames 112 of the video data 110 can be synchronized with corresponding frames of audio data 114. The audio data 114 may include raw audio information, such as sound recordings or speech, which can be captured or generated with the frames 112 of the video data 110. In some implementations, the audio data 114 can be synchronized with the frames 112 of the video data 110, such that each frame 112 corresponds to a specific segment of the audio data 114. The audio data 114 can include temporal information, such as timestamps, to indicate the timing of audio samples relative to the video frames 112. For example, the timestamps can be embedded in the audio data 114 as part of metadata or can be derived from the frame rate of the video data 110. In some implementations, the audio data 114 can also be divided into audio packets, each of which can include a timestamp indicating the playback time relative to the corresponding video frame 112.

In some implementations, the audio data 114 can be generated with the frames 112 of the video data 110, such as through a microphone capturing audio in real-time while a camera captures video frames 112. In some implementations, the audio data 114 can be pre-recorded and synchronized with the video data 110 during post-processing. For example, the audio data 114 can be extracted from an audio file and aligned with the video frames 112 based on their respective timestamps. In some implementations, the audio data 114 can be generated, for example, by an interactive application (e.g., a remote gaming application).

The streaming system 102 can stream the video data 110 to the receiver system 104 via the network. To stream the video data 110, the streaming system 102 can encode the frames 112 of the video data 110 using the video encoder 116. The video encoder 116 can be implemented as hardware, software, or a combination of hardware and software. The encoding process can involve various techniques such as compression and formatting according to video coding standards (e.g., H.264, H.265, etc.). For example, the video encoder 116 can execute encoding algorithms to transform the raw pixel data of the frames 112 into a compact representation (e.g., an encoded format).

In some implementations, the video encoder 116 can perform encoding operations such as chroma subsampling, discrete cosine transforms, and entropy coding to convert raw video frames 112 into encoded frames 124 of a video bitstream 132. The encoding process can include predictive coding, where each frame 112 is predicted based on previous frames, and the residual difference is encoded. In some implementations, the video encoder 116 can implement techniques such as motion estimation and motion compensation to reduce redundancy between frames. The output of the video encoder 116 can be a sequence of encoded frames 124 formatted as a video bitstream 132. The encoded video frames 124 can structure to facilitate decoding via the receiver system 104, as described in further detail herein.

The encoded frames 124 can include video data formatted according to various standardized codecs, such as H.264 or H.265. The H.264 format may sometimes be referred to as the MPEG-4 AVC format. Encoding the video frames 112 in the H.264 format can include performing encoding techniques such as inter and intra prediction, transform, and entropy coding. The H.265 format is sometimes referred to as the High Efficiency Video Coding (HEVC) format. In some implementations, codecs such as VP9, AV1, or other codecs may be used to generate the encoded frames 124.

In some implementations, the encoded frames 124 can include one or more of a frame header, a slice layer, and entropy-coded data. For example, when encoding according to the H.264 format, the frame header can include parameters such as frame type, macroblock coding modes, and motion vector data, while the slice layer can include data for individual slices of the frame, including transform coefficients and residual data. The entropy-coded data can represent quantized transform coefficients and other syntax elements encoded using variable-length codes or arithmetic coding.

The audio encoder 120 can encode the audio data 114 to generate encoded audio data 126. The audio encoder 120 can include hardware, software, or a combination of hardware and software. The encoded audio data 126 can include encoded audio frames, in some implementations. The encoding process can involve various techniques such as compression, transform, and quantization, among others. The encoded audio data 126 can be formatted according to standardized audio codecs, such as Advanced Audio Coding (AAC), MP3, or Opus, among others. In some implementations, the audio encoder 120 can implement lossy compression, which can reduce the bitrate while maintaining acceptable audio quality. In some implementations, the audio encoder 120 can implement lossless compression, preserving the original audio data while reducing the size.

In some implementations, to encode the audio data 114, the audio encoder 120 can perform a Fourier transform to convert time-domain audio samples into frequency-domain coefficients. The frequency-domain coefficients can then be quantized and encoded using techniques such as Huffman coding or arithmetic coding. In some implementations, the audio encoder 120 can use perceptual audio coding techniques to discard less audible components of the audio signal. For example, the audio encoder 120 can apply a psychoacoustic modeling technique to determine which frequency components can be quantized or discarded without significantly affecting perceived audio quality.

The encoded audio data 126 can be structured according to any selected encoded audio format. For example, when encoded according to the AAC format, the encoded audio data 126 can include a series of audio frames, each including a header and a payload. The header can specify parameters such as the audio codec type, sample rate, and channel configuration, while the payload can include the encoded audio samples. In some implementations, the encoded audio data 126 can be organized into packets, each including a timestamp to facilitate synchronization with the video data. For example, in the Opus format, the encoded audio data 126 can be divided into frames of varying lengths, such as 2.5 ms, 5 ms, 10 ms, 20 ms, or 40 ms, depending on the bitrate of the encoding process. In some implementations, the encoded audio data 126 can also include metadata, such as equalization coefficients or channel mapping information.

To synchronize the encoded video frames 124 and the encoded audio data 126, the streaming system 102 can execute the header updater 122 to combine portions of the encoded audio data 126 with the encoded video frames 124. The header updater 122 can include hardware, software, or a combination thereof to embed encoded audio data 126 into the encoded video frames 124. In some implementations, the header updater 122 can modify the encoded video frames 124 by incorporating the encoded audio data 126 into the headers of the encoded video frames 124. For example, the header updater 122 can embed the encoded audio data 126 into SEI fields or other header fields of the encoded video frames 124. To do so, the header updater 122 can write the encoded audio data 126 into SEI message fields, which can be part of the video frame headers. In some implementations, the header updater 122 can update the field such that the SEI messages can include timing information, such that the audio data 114 remains synchronized with the video frames 112 during playback.

In some implementations, the header updater 122 can further compress, format, or otherwise structure the encoded audio data 126 to fit within the available space in the video frame headers. Embedding the audio data 126 within the encoded video frames 124 can ensure that the audio is transmitted in synchronization with the corresponding video frames 112, without requiring separate bitstreams for each media type. The resulting video bitstream 132 includes data for both the encoded video frames 124 and the encoded audio data 126 in a single media stream. The header updater 122 can perform various techniques to subdivide or otherwise include the encoded audio data 126 within one or more of the encoded video frames 124.

For example, in some implementations, the header updater 122 can subdivide the encoded audio data 126 according to the frame rate of the video data 110, such that each portion of the audio data is embedded within the header of a corresponding video frame 112. To do so, the header updater 122 can select a subset of the encoded frames 124 to update to include the encoded audio data 126 based on the framerate of the video data 110 and/or a framerate of the audio data 114. In some implementations, the frames/portions of the encoded audio data 126 may be inserted into frames on a predetermined basis (e.g., once every frame, once every two frames, etc.). In some implementations, a subset of encoded video frames 124 to update may be selected based on the playback duration of each of frame/portion of encoded audio data 126 and the playback duration of each encoded video frame 124.

In an example the video data 110 has a frame rate of 16.67 milliseconds per frame (e.g., 60 frames per second) and the audio data 114 has a frame size of 20 milliseconds per frame (e.g., 50 frames per second), the header updater 122 can select a subset of the encoded video frames 124 representing a common time period (e.g., 100 ms) to update with corresponding frames/portions of encoded audio data 126. In this example, the header updater 122 can determine that five encoded video frames 124 (each representing 16.67 milliseconds of video data) correspond to five audio frames (each representing 20 milliseconds of audio data), within a 100ms time period. In some implementations, the time period may be selected to span both a playback duration of a whole number of encoded video frames 124 (e.g., six frames in the above example) and a whole number of encoded frames/portions of encoded audio data 126 (e.g., five frames in the above example). Different time periods may be selected/determined for different frame rates of video/audio.

To maintain synchronization in the above example, the header updater 122 can embed one frame/portion of encoded audio data 126 into the header of five encoded video frames 124 of the time period. The sixth encoded video frame 124, which corresponds to the remaining 16.67 milliseconds of the 100-millisecond time period, can be updated to include metadata (e.g., synchronization markers or other control data) instead of encoded audio data 126. In some implementations, the header updater 122 may not update encoded video frames 124 that are not selected to include portions of encoded audio data 126. Updating the encoded video frames 124 using such approaches can ensure that the encoded audio data 126 remains synchronized with the corresponding encoded video frames 124 while evenly distributing encoded audio data 126 across the encoded video frames 124.

Once the encoded video frames 124 are generated and/or updated, the network packet transmitter 128 can generate and transmit network packets 130 including the encoded video bitstream 132. The network packet transmitter 128 can include hardware, software, or combinations thereof to facilitate the transmission of encoded video data via the network 118. The network packet transmitter 128 can access the encoded video frames 124, which may include embedded audio data 126, and serialize the encoded video frames 124 into a video bitstream 132 for transmission over the network 118. The serialization process can involve concatenating the encoded frames 124 and/or inserting control data or metadata, such as timestamps or sequence numbers, to maintain the integrity and order of the video bitstream 132 during transmission.

The network packet transmitter 128 can generate network packets 130 by segmenting the serialized video bitstream 132 into appropriately sized packets based on network constraints, network protocols, or configuration settings, among others. The network packets 130 may be generated/transmitted according to any suitable protocol, including but not limited to transmission control protocol (TCP) or user datagram protocol (UDP) packets. Each network packet 130 can include a portion of the video bitstream 132, along with packet headers that provide addressing, sequencing, and other control information. In some implementations, the network packet transmitter 128 can generate network packets 130 to include the video bitstream 132 according to the Real-Time Streaming Protocol (RTSP) or the Real-Time Transport Protocol (RTP). For example, when using RTP, the network packet transmitter 128 can encapsulate the video bitstream 132 within RTP packets, which can include timestamps and sequence numbers to facilitate synchronized playback at the receiver system 104. In some implementations, the network packet transmitter 128 can transmit the network packets 130 via a single RTP port. In some implementations, the network packet transmitter 128 can communicate with one or more receiver systems 104 to handle error correction or retransmission of dropped and/or corrupted network packets 130.

The receiver system 104 can receive one or more network packets 130 via the network 118. The receiver system 104 can be any type of computing device that can receive, process, and/or provide video/audio data for presentation. The receiver system 104 can reassemble the video bitstream 132 from the network packets 130. In some implementations, the receiver system 104 can process the network packets 130 in accordance with their sequence numbers or timestamps included in the packet headers. Once reassembled, the receiver system 104 can deserialize the video bitstream 132 into corresponding encoded video frames 124. For example, the receiver system 104 can parse the video bitstream 132 to identify the boundaries of each encoded video frame 124, such as by detecting frame headers or other structural markers. The encoded video frames 124, once deserialized from the video bitstream 132, can be processed as described herein.

In some implementations, the receiver system 104 can detect corrupted or lost network packets 130 during the re-assembly process. For example, the receiver system 104 can identify missing packets based on gaps in sequence numbers or timestamps. In response, the receiver system 104 can request retransmission of the corrupted or lost packets by transmitting a retransmission request to the streaming system 102 or another system responsible for transmitting the network packets 130. The retransmission request can specify the sequence numbers or timestamps of the missing packets to facilitate accurate retransmission. Upon receiving the retransmitted packets, the receiver system 104 can re-assemble the video bitstream 132 and continue decoding and presenting the video and audio data in synchronization.

The receiver system 104 can execute the audio extractor 105 to extract encoded audio data 126 from the encoded video frames 124 of the video bitstream 132. The audio extractor 105 can include hardware, software, or combinations thereof. The audio extractor 105 can identify and parse the encoded audio data 126 embedded within the headers or other metadata fields of the encoded video frames 124. In response to receiving the encoded video frames 124, the audio extractor 105 can extract the encoded audio data 126 by reading the corresponding fields within each frame. The audio extractor 105 can further assemble a sequence of encoded audio data 126 from a sequence of one or more encoded video frames 124, ensuring that the audio data is correctly ordered and synchronized with the corresponding video content. In some implementations, the audio extractor 105 can buffer multiple encoded video frames 124 to collect and concatenate the embedded audio data 126 into a contiguous audio bitstream. The audio extractor 105 can also verify the integrity of the extracted audio data 126, for example, by validating timestamps or sequence markers embedded within the encoded audio data 126. Once extracted, the audio extractor 105 can provide the encoded audio data 136 to an audio decoder 108 and the encoded video frames 124 to the video decoder 106.

The video decoder 106 can decode the encoded video frames 124 to generate decoded video data 134. The video decoder 106 can include hardware, software, or a combination thereof to decode the encoded video frames 124. The decoding process can involve various operations such as parsing the encoded video frames 124, extracting the video data, and reconstructing the original frames. For example, the video decoder 106 can execute decoding algorithms to reverse the encoding process performed by the video encoder 116 of the streaming system 102. Decoding can include operations such as entropy decoding, inverse transforms, and motion compensation, among others, to reconstruct the original pixel data.

The video decoder 106 can process frame headers, slice layers, and other syntax elements to interpret the encoded video frames 124. In some implementations, the video decoder 106 can perform, for example, de-blocking and/or de-ringing operations to improve the visual quality of the decoded frames. The decoded video data 134 generated by the video decoder 106 can represent the original frames 112 of the video data 110. Each decoded frame can include pixel data, which can be stored or processed sequentially to maintain the frame rate and timing of the original video data 110.

For example, the decoded video data 134 can include raw pixel data, which can be rendered or processed using other downstream processing operations. In some implementations, the decoded video data 135 can include metadata, such as timestamps or sequence information, to facilitate synchronization with the decoded audio data 136. The receiver system 104 can provide the decoded video data 134 to a display system, another computing device/system, or other processes of the receiver system 104 for rendering and/or processing. In some implementations, the video decoder 106 can implement error correction or concealment of corrupted frames, if any, to maintain video quality.

The audio decoder 108 can decode the encoded audio data 126 to generate decoded audio data 136. The audio decoder 108 can include hardware, software, or a combination thereof to process the encoded audio data 126. The decoding process can involve reversing the encoding operations performed by the audio encoder 120. For example, the audio decoder 108 can execute decoding algorithms to transform the encoded audio data 126 into a sequence of time-domain audio samples. The decoding process may involve operations such as inverse quantization, inverse transforms, or entropy decoding, among others. In some implementations, the audio decoder 108 can process metadata embedded in the encoded audio data 126, such as timestamps or channel configuration information, to re-assemble the audio stream and synchronize with the decoded video data 134. The decoded audio data 136 can represent a sequence of time-domain audio samples that correspond to the original audio data 114. The decoded audio data 136 can include audio samples organized in a specific format, such as 16-bit or 24-bit integer values, representing sound pressure levels at specific points in time. In some implementations, the audio decoder 108 can generate the decoded audio data 136 as an audio stream.

The receiver system 104 can provide the decoded video data 134 and the decoded audio data 136 for presentation or further processing, which may include synchronizing the decoded video data 134 and audio data 136 for presentation and/or processing. The synchronization can be based on the timing information embedded in the decoded video data 134 and decoded audio data 136, such as timestamps or sequence markers. For example, the timestamps in the headers of the encoded video frames 124 can indicate the playback timing of the corresponding audio data 114. The receiver system 104 can use these timestamps to align the decoded audio data 136 with the decoded video data 134 during playback. In some implementations, the receiver system 104 can implement additional synchronization mechanisms, such as buffering or adjusting playback rates, to maintain synchronization between the video and audio data.

In some implementations, the receiver system 104 can provide network performance data for the video bitstream 132 to the streaming system 102. Network performance data can include metrics such as latency, jitter, packet loss, or available bandwidth, among others. The streaming system 102 can use the network performance data to update the bitrate of the video stream. In some implementations, the receiver system 104 can generate network performance data by monitoring the arrival times of network packets 130, measuring the variation in packet arrival times (jitter), detecting lost or corrupted packets, and/or estimating the available bandwidth based on the rate of packet delivery, among other approaches. The receiver system 104 can provide the network performance data to the streaming system 102 via one or more feedback messages, such as RTP Control Protocol (RTCP) messages or Google Remote Procedure Call (gRPC) messages, among others. The streaming system 102 can use the network performance data to optimize the video bitstream 132 by adjusting encoding parameters, bitrate, or packetization strategies to better match the network conditions.

In some implementations, the streaming system 102 can dynamically adjust the bitrate of the video bitstream 132 based on the network performance data received from the receiver system 104. To do so, the streaming system 102 can analyze the network performance data to determine a bit rate adjustment. For example, if the receiver system 104 reports high packet loss or increased latency, the streaming system 102 can reduce the bitrate of the video bitstream 132 to prevent further network congestion and ensure smooth playback. Conversely, if the network performance data indicates low latency and high bandwidth availability, the streaming system 102 can increase the bitrate to improve video quality. The streaming system 102 can adjust the bitrate, for example, by adjusting the encoding parameters of the video encoder 116. The adjusted encoding parameters may include quantization levels or frame rates. In some implementations, the streaming system 102 can modify the packetization process implemented by the network packet transmitter 128 to generate packets of appropriate sizes for the current network conditions. The streaming system 102 can adjust the parameters of the encoding process in real-time or near real-time to improve streaming performance.

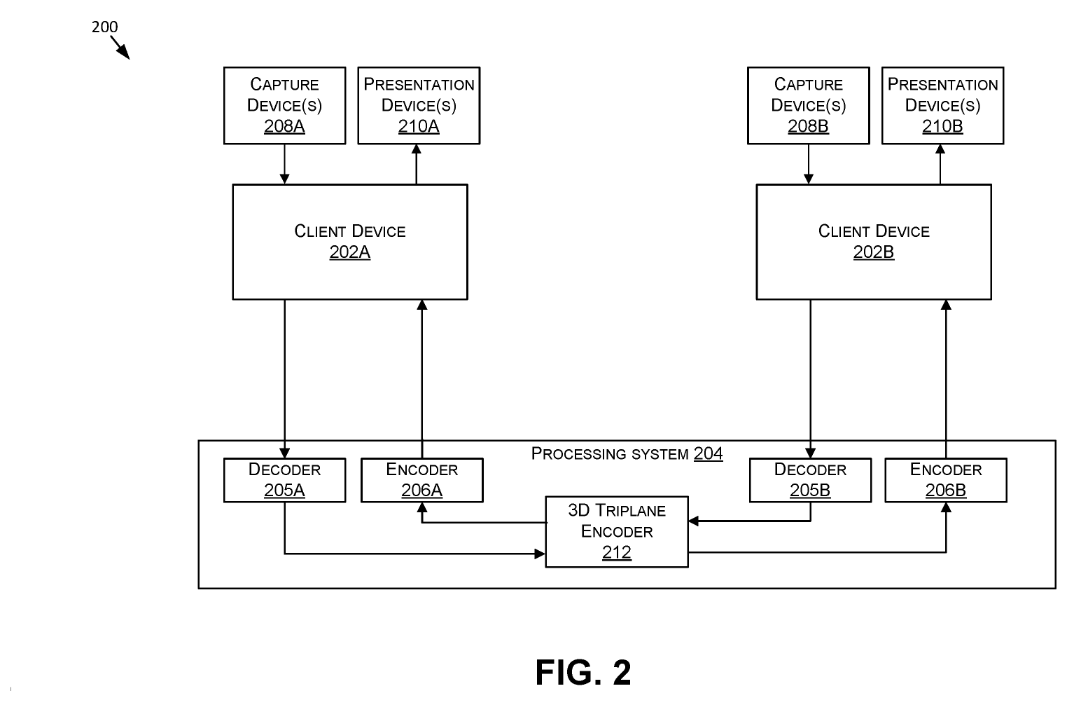

Referring to FIG. 2 in the context of the components described in connection with FIG. 1, illustrated is a block diagram showing an example environment 200 in which the media synchronization techniques in connection with FIG. 1 can be implemented for an example video conferencing application, in accordance with some embodiments of the present disclosure. The environment 200 includes the client device 202A, the client device 202B, and a processing system 204. Each of the client device 202A, the client device 202B, and the processing system 204 may communicate via one or more networks (e.g., the network 118 of FIG. 1). Each of the client device 202A, the client device 202B, and the processing system 204 can implement the functionalities of both the streaming system 102 and the receiver system 104, as described in connection with FIG. 1.

In this example, the client devices 202A and 202B can operate as endpoints in an example 2D-to-3D video conferencing application. The client devices 202A and 202B can include or communicate with respective capture devices 208A and 208B, which can acquire video and audio data from the local environment. For example, the capture devices 208A and 208B can include cameras and microphones that capture visual and audio content, respectively, and provide the captured data to the client devices 202A and 202B for processing. The client devices 202A and 202B can encode the captured video and audio data, synchronize the data, and transmit it to the processing system 204 or directly to each other/another client device, using techniques described in connection with FIG. 1 (e.g., with the client devices 202A and 202B each operating as streaming systems 102, and the processing system 204 operating as a receiver system 104, etc.). The presentation devices 210A and 210B can be connected to or integrated with the client devices 202A and 202B to output video and audio content. The presentation devices 210A and 210B can include displays and speakers that render the received video and audio data.

Each client device 202A and 202B can generate encoded video bitstreams 132 according to the techniques described in connection with FIG. 1 and can transmit the bitstreams to the processing system 204. For example, each client device 202A and 202B can execute a respective video encoder 116 and audio encoder 120 to encode video frames 112 and audio data 114 into encoded formats (e.g., encoded video frames 124, encoded audio data 126). Each client device 202A and 202B can embed the encoded audio data 126 into the encoded video frames 124, for example, by inserting the audio data into SEI fields or other header fields, as described herein. Each client device 202A and 202B can serialize the encoded video frames into a respective video bitstream 132 and can transmit the encoded bitstream to the processing system 204 in one or more network packets (e.g., network packets 130).

The processing system 204 can operate as an intermediary cloud-based system or distributed computing platform that can process video streams transmitted by the client devices 202A and 202B and can route the processed video streams to the corresponding destination client device 202A and 202B. The processing system 204 can include one or more servers, data centers, or distributed computing nodes configured to receive, process, and transmit multimedia data. In some implementations, the processing system 204 can perform video processing operations such as 2D-to-3D conversion, resolution scaling, or frame rate adjustment.

The processing system 204 can include a decoder 205A and an encoder 206A for video streams received from and transmitted to the client device 202A, and a decoder 205B and an encoder 206B for video streams received from and transmitted to the client device 202B. The decoders 205A and 205B can perform any of the functionality described in connection with the receiver system 104 to generate decoded video data 134 and decoded audio data 136. For example, the decoders 205A and 205B can receive encoded video frames 124 from the client devices 202A and 202B, can extract the encoded audio data 126 embedded in the metadata (e.g., SEI fields), and can decode both the video and audio data using the techniques described herein. The decoded video data 134 and decoded audio data 136 can then be provided to the 3D triplane encoder 212 for further processing. In some implementations, the decoders 205A and 205B can also synchronize the decoded video data 134 and decoded audio data 136 based on timestamps or other synchronization markers embedded in the encoded video frames 124.

The 3D triplane encoder 212 can process respective streams of decoded video data 136 provided from the decoders 205A and 205B to generate corresponding 3D rendering metadata for each video stream. The 3D triplane encoder 212 can analyze the decoded video frames and produce various metadata that may facilitate 3D rendering, such as depth information, camera parameters, or scene geometry, among others. In some implementations, the 3D triplane encoder 212 can generate the 3D rendering metadata by mapping the decoded video frames to a three-dimensional representation, such as a triplane projection. The 3D triplane encoder 212 can provide the decoded video data 134 and decoded audio data 136, which may be at least in part processed using any suitable processing technique, along with the 3D rendering metadata, to the encoders 206A and 206B. Although this example involves the generation of 3D rendering metadata, it should be understood that any processing technique may be used to process the decoded video data 134 and decoded audio data 136 prior to re-encoding.

The encoders 206A and 206B can re-encode each of the decoded video streams according to the techniques described in connection with FIG. 1. In some implementations, the encoders 206A and 206B can embed 3D rendering metadata into the re-encoded video streams, such as in one or more header fields of the encoded video frames 124. Embedding the 3D rendering metadata can be performed similarly to how encoded audio data 126 is embedded into the header field(s) of encoded video frames 124, as described herein. Each of the encoders 206A and 206B can serialize the encoded video frames and transmit the resulting encoded bitstream 132 to the destination client devices 202A and 202B, as shown.

Each client device 202A and 202B can receive a respective encoded bitstream and can decode the bitstream according to the techniques described in connection with FIG. 1. The client devices 202A and 202B can receive the encoded bitstream, which includes encoded video frames 124 with embedded encoded audio data 126 and 3D rendering metadata. The encoded bitstreams 132 can be processed by each client device 202A and 202B using similar techniques to those described in connection with the receiver system 104 of FIG. 1, to generate decoded video data 134, decoded audio data 136, and extracted 3D rendering metadata.

The extracted 3D rendering metadata can be used by the client devices 202A and 202B to render the decoded video data 134 in a 3D format, for example, by adjusting the perspective, depth, or other visual attributes of the video content. Each client device 202A and 202B can render 3D video and provide audio output via the presentation devices 210A and 210B using the decoded video data 134, the extracted 3D rendering metadata, and decoded audio data 136. The techniques described in connection with FIG. 2 can be performed continuously as part of a video conferencing application, such that each client device 202A and 202B can receive and present video and audio from the other client device 202B and 202A in real-time or near real-time.

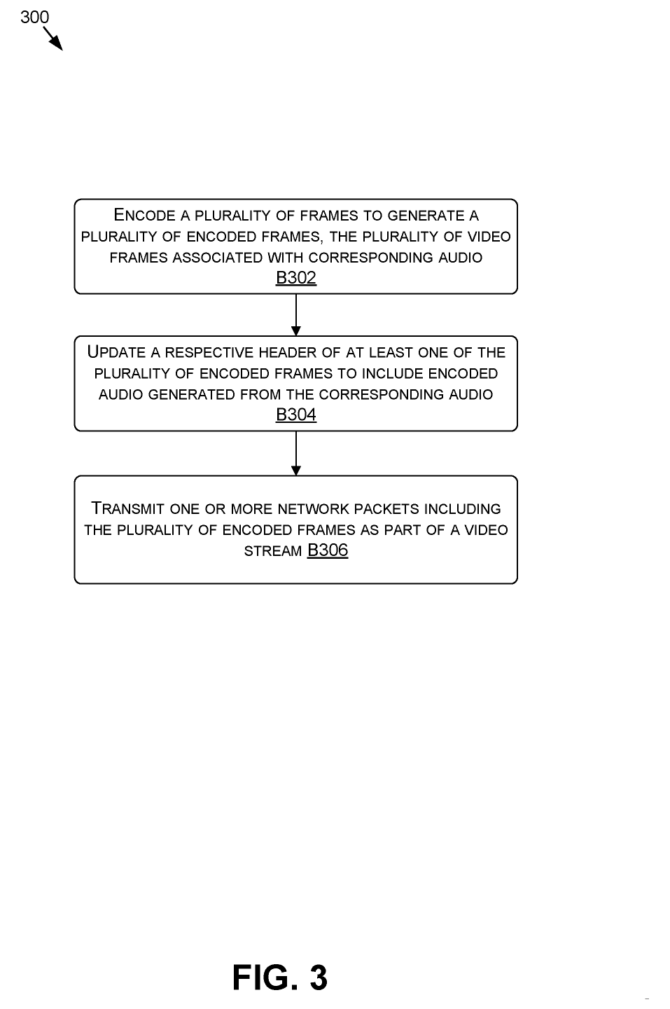

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for implementing media synchronization for cloud processing, in accordance with some embodiments of the present disclosure. The method 300, at block B302, can include encoding a plurality of frames (e.g., frames 112 of video data 110) to generate a plurality of encoded frames (e.g., encoded video frames 124). The video frames can be associated with corresponding audio data 114. The encoding process can be performed using video encoding standards such as H.264 or H.265. These standards can employ compression techniques, including chroma subsampling, discrete cosine transforms, and entropy coding. Predictive coding and motion estimation can also be applied to reduce redundancy between frames. The resulting encoded frames can include headers, slice layers, and entropy-coded data. The audio data 114 can be encoded into formats such as AAC or Opus using lossy or lossless compression techniques. The audio encoding techniques can include Fourier transforms or psychoacoustic modeling.

The method 300, at block B304, can include updating a respective header of at least one of the plurality of encoded frames to include encoded audio data (e.g., encoded audio data 126) generated from the corresponding audio data 114. The encoded audio data can be embedded in SEI fields or other header fields of the encoded video frames. The audio data can be subdivided based on the video frame rate, such that each portion of audio data corresponds to a specific video frame. This subdivision ensures synchronization between the audio and video data. The headers (e.g., one or more header fields) of the encoded video frames can be modified/updated/re-purposed to include the encoded audio data. In some implementations, the updates to encoded video frames can be applied selectively based at least on the durations of the encoded video frames and encoded audio frames. For example, the header updater can embed audio portions into video frames at specific intervals to maintain temporal alignment, as described in connection with FIG. 1.

The method 300, at block B306, can include transmitting one or more network packets (e.g., network packets 130) including the encoded frames as part of a video stream (e.g., the bitstream 132). The encoded frames, which include the embedded audio data, can be serialized into a video bitstream. The network packets can be formatted according to protocols such as RTP or RTSP. The packets can be transmitted over one or more networks, where they can be routed to one or more receiver systems (e.g., receiver system 104) for decoding and playback. During transmission, the network packets can be monitored for latency, packet loss, or other network conditions that may affect streaming performance. In some implementations, the computing system performing the method 300 can adapt to changing network conditions by adjusting the bitstream parameters, as described in connection with FIG. 1.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models – such as one or more large language models (LLMs), one or more small language models (SLMs), one or more vision language models (VLMs), and/or one or more multimodal language models (MMLMs), systems for performing light transport simulation, systems for performing collaborative content creation for 3D assets, systems implemented at least partially using cloud computing resources, and/or other types of systems.

### EXAMPLE COMPUTING DEVICE

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs) – e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that allow the computing device 400 to communicate with other computing devices via an electronic communication network, included wired and/or wireless communications. The communication interface 410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may allow the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that allow detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to allow the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### EXAMPLE DATA CENTER

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-516(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark^{TM} (hereinafter “Spark”) that may use distributed file system 538 for large-scale data processing (e.g., "big data"). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4 – e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
encode a plurality of video frames to generate a plurality of encoded frames, the plurality of video frames associated with corresponding audio;
update a respective header of at least one of the plurality of encoded frames to include encoded audio generated from the corresponding audio; and
transmit one or more network packets including the plurality of encoded frames as part of a video stream.

2. The one or more processors of claim 1, wherein the one or more circuits are to:
generate a plurality of encoded audio frames from the corresponding audio; and
update the respective header of one or more of the plurality of encoded frames to include a respective encoded audio frame of the plurality of encoded audio frames.

3. The one or more processors of claim 2, wherein the one or more circuits are to:
select, based at least on a framerate of the video stream, a subset of the plurality of encoded frames to update to include one or more of the plurality of encoded audio frames.

4. The one or more processors of claim 3, wherein the encoded audio is stored as a plurality of encoded audio frames, wherein the one or more processors are to:
determine a playback duration of each of the plurality of encoded audio frames; and
select the subset of the plurality of encoded frames further based at least on the playback duration.

5. The one or more processors of claim 1, wherein the one or more circuits are to:
update the respective header to include the encoded audio as Supplemental Enhancement Information (SEI) metadata.

6. The one or more processors of claim 1, wherein the one or more circuits are to:
receive feedback from a computing system indicating network performance information; and
dynamically adjust a bit rate of the video stream based at least on the network performance information.

7. The one or more processors of claim 1, wherein the plurality of encoded frames is generated according to one of a H.264 format or a H.265 format.

8. The one or more processors of claim 1, wherein the one or more circuits are to:
transmit the one or more network packets including the plurality of encoded frames via a single real-time transport protocol (RTP) port.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a small language model (SLM);
a system for performing generative AI operations using a vision language model (VLM);
a system for generating synthetic data;a system incorporating one or more virtual machines (VMs);
a system implemented at least partially in a data center; or
a system implemented at least partially using cloud computing resources.

10. A system, comprising:
one or more processors to:
receive one or more network packets comprising one or more encoded video frames of a video stream;
extract one or more encoded audio frames from respective headers of the one or more encoded video frames;
decode the one or more encoded video frames and the one or more encoded audio frames to generate one or more decoded video frames and decoded audio data; and
provide the one or more decoded video frames and the decoded audio data for presentation or processing.

11. The system of claim 10, wherein the one or more processors are to:
deserialize the video stream to generate the one or more encoded video frames.

12. The system of claim 10, wherein the one or more processors are to:
extract the one or more encoded audio frames from at least one supplement enhancement information (SEI) fields of the respective headers of the one or more encoded video frames.

13. The system of claim 10, wherein the one or more processors are to:
extract three-dimensional (3D) rendering metadata from the respective headers of the one or more encoded video frames; and
render a 3D output based at least on the 3D rendering metadata and the one or more decoded video frames.

14. The system of claim 10, wherein the one or more processors are to:
generate three-dimensional (3D) rendering metadata using the one or more decoded video frames.

15. The system of claim 14, wherein the one or more processors are to:
re-encode the one or more decoded video frames and the audio data to generate one or more re-encoded video frames and re-encoded audio data;
update a respective header of at least one of the one or more re-encoded video frames to include the re-encoded audio data and the 3D rendering metadata; and
transmit one or more network packets including the one or more re-encoded video frames as part of a video stream.

16. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a small language model (SLM);
a system for performing generative AI operations using a vision language model (VLM);
a system for generating synthetic data;
a system incorporating one or more virtual machines (VMs);
a system implemented at least partially in a data center; or
a system implemented at least partially using cloud computing resources.

17. A method, comprising:
encoding, using one or more processors, a plurality of video frames to generate a plurality of encoded frames, the plurality of video frames associated with corresponding audio;
updating, using the one or more processors, a respective header of at least one of the plurality of encoded frames to include encoded audio generated from the corresponding audio; and
transmitting, using the one or more processors, one or more network packets including the plurality of encoded frames as part of a video stream.

18. The method of claim 17, further comprising:
generating, using the one or more processors, a plurality of encoded audio frames from the corresponding audio; and
updating, using the one or more processors, the respective header of one or more of the plurality of encoded frames to include a respective encoded audio frame of the plurality of encoded audio frames.

19. The method of claim 18, further comprising:
selecting, using the one or more processors, based at least on a framerate of the video stream, a subset of the plurality of encoded frames to update to include one or more of the plurality of encoded audio frames.

20. The method of claim 19, wherein the encoded audio is stored as a plurality of encoded audio frames, and further comprising:
determining, using the one or more processors, a playback duration of each of the plurality of encoded audio frames; and
selecting, using the one or more processors, the subset of the plurality of encoded frames further based at least on the playback duration.
